(19) United States
(12) Patent Application Publication
(10) Pub. No.: US 2024/0304792 A1
(43) Pub. Date: Sep. 12, 2024

(54) POSITIVE ELECTRODE ACTIVE MATERIAL FOR SULFIDE-BASED ALL-SOLID-STATE BATTERY

(71) Applicant: LG Energy Solution, Ltd., Seoul (KR)

(72) Inventors: Dae Jin Lee, Daejeon (KR); Ji Young Kim, Daejeon (KR); Lak Young Choi, Daejeon (KR); Hoe Jin Hah, Daejeon (KR)

(21) Appl. No.: 18/028,494

(22) PCT Filed: Aug. 30, 2022
(86) PCT No.: PCT/KR2022/012931

§ 371 Date: Mar. 24, 2023

(30) Foreign Application Priority Data
Dec. 7, 2021 (KR) 10-2021-0173748

(51) Int. Cl. H01M 4/36; C01G 53/00; H01M 4/525; H01M 10/052; H01M 10/0562

(52) U.S. Cl. CPC H01M 4/366; C01G 53/50; H01M 4/525; H01M 10/052; H01M 10/0562; C01P 2002/50; C01P 2004/84; C01P 2006/40; H01M 2300/0068

(57) ABSTRACT

A positive electrode active material for an all-solid-state battery, a method of preparing the same, and an all-solid-state battery including the same are provided. The positive electrode active material includes a core containing a lithium metal oxide represented by Liₓ[Ni_{y}Co_{z}Mn_{w}M¹ᵥ]Oᵤ, which contains a high nickel content and a low cobalt content, and a shell containing niobium and tungsten and adsorbed on a surface of the core, and thereby providing advantageous effect of engancing discharge performance of a battery by enhancing lithium ion mobility and reducing a side reaction between the positive electrode active material and a solid electrolyte.

### CROSS-REFERENCE TO RELATED APPLICATION(S)

This application is a National Stage Application of International Application No. PCT/KR2022/012931, filed on Aug. 30, 2022, which claims the benefit of priority based on Korean Patent Application No. 10-2021-0173748, filed on Dec. 7, 2021, the disclosures of which are incorporated herein by reference in their entireties. Field

The present invention relates to a positive electrode active material for a sulfide-based all-solid-state battery.

### BACKGROUND

All-solid-state lithium batteries are batteries that use sulfide-based or oxide-based solid electrolytes and are capable of directly converting chemical energy into electrical energy by oxidizing or reducing lithium ions with an all-solid-state material as a medium.

Batteries using solid electrolytes exhibit excellent stability compared to an existing liquid electrolyte system, but performance such as capacity, output, and the like still falls short of the existing liquid electrolyte system due to low ion conductivity of the solid electrolyte. The reason why ion conductivity is low in batteries using solid electrolytes is that a contact area between an electrode active material and the solid electrolyte is small compared to the conventional liquid electrolyte system and the inherent ion conductivity of the solid electrolyte is low.

Specifically, all-solid-state batteries have problems such as capacity degradation and the like due to irreversibility caused by an interfacial side reaction between a sulfide-based or oxide-based solid electrolyte and a positive electrode during a charging and discharging reaction and non-uniform distribution of electrode charges caused by interfacial resistance and space-charge layer formation.

In order to solve this problem, a coating technique capable of passivating the surface of a conventional positive electrode active material has been proposed. Passivation is treatment of a surface of any material so that the inherent properties thereof are not changed by external conditions or stimuli, for example, a treatment such as an anticorrosion treatment to prevent formation of rust, which is immediately formed when a clean surface of iron meets oxygen in the air, is called passivation.

However, despite this type of effort, the charging/discharging characteristics of a battery fabricated using the passivated positive electrode active material are still poor in many aspects and still need to be improved.

Meanwhile, lithium composite metal oxides (Li(NiCoMn)O₂) as positive electrode active materials of lithium secondary batteries basically provide excellent battery characteristics, but have limitations in that safety, especially thermal safety, overcharging characteristics, and the like are insufficient.

Accordingly, attempts have been made to apply lithium composite metal oxides (Li(NiCoMn)O₂) as positive electrode active materials of all-solid-state batteries. However, in the case of batteries using the lithium composite metal oxides, particularly with a sulfide-based solid electrolyte, the stability and performance of a positive electrode active material may be degraded due to a reaction between cobalt and sulfur. Also, when the amount of cobalt in the lithium composite metal oxide is reduced to improve the above said problem, the discharge capacity of a battery is not sufficiently realized, and thus charge/discharge efficiency is substantially degraded.

### RELATED-ART

Korean Laid-Open Patent Publication No. 10-2021-0117002

### SUMMARY

### Technical Problem

The present disclosure is directed to providing a positive electrode active material for a sulfide-based all-solid-state battery, which exhibits excellent charging/discharging characteristics, especially excellent discharge capacity, of a battery by using a lithium composite metal oxide having a high nickel content and a low cobalt content, and a sulfide-based all-solid-state battery including the same.

### Technical Solution

One aspect of the present disclosure provides a positive electrode active material for an all-solid-state battery, the positive electrode active material including: a core containing a lithium metal oxide represented by the following Chemical Formula 1; and a shell adsorbed onto a surface of the core and containing niobium (Nb) and tungsten (W):

Liₓ[Ni_{y}Co_{z}Mn_{w}M¹ᵥ]Oᵤ [Chemical Formula 1]
in Chemical Formula 1,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, y, z, w, v, and u satisfy 1.0≤x≤1.30, 0.7≤y≤0.95, z≤0.07, 0.01<w≤0.3, 0≤v≤0.1, and 1.5≤u≤4.5.

In this case, the niobium (Nb) and tungsten (W) may be in the form of a mixture of niobium oxide particles and tungsten oxide particles or in the form of niobium tungsten oxide particles.

In addition, the niobium (Nb) and tungsten (W) may be contained in an amount of 0.01 to 5 wt % with respect to the total weight of the positive electrode active material.

Additionally, the niobium (Nb) may be contained at 2,500 ppm or more with respect to the total positive electrode active material, and the tungsten (W) may be contained at 6,000 ppm or less with respect to the total positive electrode active material.

In addition, a content ratio (Nb/W) of the niobium (Nb) to the tungsten (W) contained in the shell may be 0.1 to 3.0.

Additionally, the positive electrode active material may have an average particle size of 0.5 μm to 10 μm.

In addition, the shell may be adsorbed onto 60% or more of the total surface area of the core.

Another aspect of the present disclosure provides a method of preparing a positive electrode active material for an all-solid-state battery, the method including: preparing a mixture including a lithium metal oxide represented by the following Chemical Formula 1 and a niobium (Nb) and tungsten (W)-containing oxide: and thermally treating the mixture:

Liₓ[Ni_{y}Co_{z}Mn_{w}M¹ᵥ]Oᵤ [Chemical Formula 1]
in Chemical Formula 1,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, y, z, w, v, and u satisfy 1.0≤x≤1.30, 0.7≤y≤0.95, z≤0.07, 0.01<w≤0.3, 0≤v<30.1, and 1.5≤u≤4.5.

In this case, the niobium (Nb) and tungsten (W)-containing oxide may be included in an amount of 0.1 to 10 wt % with respect to the total weight of the mixture.

In addition, the thermally treating may be performed at 300° C. to 500° C.

Still another aspect of the present disclosure provides an all-solid-state lithium secondary battery, which includes: a positive electrode including the above-described positive electrode active material according to the present disclosure: a negative electrode; and a sulfide-based solid electrolyte disposed between the positive electrode and the negative electrode.

In this case, the sulfide-based solid electrolyte may include one or more selected from the group consisting of Li₂S—SiS₂, LiI—Li₂S—SiS₂, LiI—Li₂S—P₂S₅, LiI—Li₂S—B₂S₃, Li₃PO₄—Li₂S—Si₂S, Li₃PO₄—Li₂S—SiS₂, LiPO₄—Li₂S—SiS, LiI—Li₂S—P₂O₅, LiI—Li₃PO₄-P₂S₅, and Li₂S—P₂S₅.

### Advantageous Effects

A positive electrode active material for an all-solid-state battery according to the present disclosure is effective for enhancing lithium ion mobility, reducing a side reaction between the positive electrode active material and a solid electrolyte, and thus enhancing the discharge performance of a battery by including a lithium metal oxide of Chemical Formula 1, which has a high nickel content and a low cobalt content, as a core and a shell containing niobium and tungsten on the surface of the core.

### DETAILED DESCRIPTION

As the present disclosure allows for various changes and a variety of embodiments, particular embodiments will be described in detail in the detailed description.

However, this is not intended to limit the present disclosure to specific embodiments, and it should be understood that all changes, equivalents, or substitutes within the spirit and technical scope of the present disclosure are included in the present disclosure.

In the present disclosure, it should be understood that the term “include(s)” or “have(has)” is merely intended to indicate the presence of features, numbers, steps, operations, components, parts, or combinations thereof, and not intended to preclude the possibility of the presence of addition of one or more other features, numbers, steps, operations, components, parts, or combinations thereof.

In addition, in the present disclosure, when a portion of a layer, film, region, plate, or the like is referred to as being “on” another portion, this includes not only the case where the portion is “directly on” it but also the case where there is another portion interposed therebetween. Conversely, when a portion of a layer, film, region, plate, or the like is referred to as being “under” another portion, this includes not only the case where the portion is “directly under” it but also the case where there is another portion interposed therebetween.

Also, herein, something referred to as being disposed “on” something else may be disposed not only on an upper part of it but also on a lower part of it.

Additionally, in the present disclosure, “being included as a main component” may mean that a component is included in an amount of 50 wt % or more, 60 wt % or more, 70 wt % or more, 80 wt % or more, 90 wt % or more, 95 wt % or more, or 97.5 wt % or more with respect to the total weight of a composition such as a slurry or a specific component. In some cases, it means that a component is included in an amount of 100 wt % when constituting the entire composition or specific component.

Hereinafter, the present disclosure will be described in further detail.

### Positive Electrode Active Material for All-Solid-State Battery

One aspect of the present disclosure provides a positive electrode active material for an all-solid-state battery, which includes: a core containing a lithium metal oxide; and a shell adsorbed onto a surface of the core and containing niobium (Nb) and tungsten (W).

The positive electrode active material according to the present disclosure is used in a sulfide-based all-solid-state lithium secondary battery and includes a lithium metal oxide, which exhibits electrical activity during charging and discharging of a battery, as a core and a shell formed by adsorbing particles containing both niobium (Nb) and tungsten (W) onto a surface of the core.

In this case, the lithium metal oxide is not particularly limited as long as it reversibly reacts to provide lithium ions during charging and discharging of a battery, and specifically, a lithium metal oxide represented by the following Chemical Formula 1 may be contained:

Liₓ[Ni_{y}Co_{z}Mn_{w}M¹ᵥ]Oᵤ [Chemical Formula 1]
in Chemical Formula 1,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, y, z, w, v, and u satisfy 1.0≤x≤1.30, 0.7≤y≤0.95, z≤0.07, 0.01<w≤0.3, 0≤v≤0.1, and 1.5≤u≤4.5.

The lithium metal oxide represented by Chemical Formula 1 is an oxide including transition metals in addition to lithium, particularly, an oxide including, among the transition metals, a large amount of nickel and a certain amount or less of cobalt. Specifically, the lithium metal oxide may include, with respect to 100 molar parts of all of nickel (Ni), cobalt (Co), manganese (Mn), and additional metals (M¹), 70 mol % or more, 75 mol % or more, 80 mol % or more, 85 mol % or more, or 90 mol % or more of nickel and 7 mol % or less, 6 mol % or less, 5 mol % or less, or 3 mol % or less of cobalt (Co).

As an example, the lithium metal oxide may include one or more selected from the group consisting of LiNi_{0.9}Co_{0.05}Mn_{0.05}O₂, LiNi_{0.8}Co_{0.05}Mn_{0.15}O₂, LiNi_{0.7}Co_{0.05}Mn_{0.25}O₂, LiNi_{0.8} Co_{0.05}Mn_{0.1}Al_{0.05}O₂, LiNi_{0.7}Co_{0.05}Mn_{0.15}Al_{0.1}O₂, LiNi_{0.7}Co_{0.05}Mn_{0.2}Al_{0.05}O₂, and LiNi_{0.8}Co_{0.05}Mn_{0.1}Al_{0.05}O₂. The lithium metal oxide is effective for enhancing the charge/discharge capacity of a battery.

In addition, the positive electrode active material has a structure in which a shell containing niobium (Nb) and tungsten (W) is adsorbed onto a surface of the core. Accordingly, an interfacial resistance between the positive electrode active material and a solid electrolyte can be reduced, and resistance to a side reaction between the positive electrode active material and a solid electrolyte can be enhanced to suppress the loss of lithium ions, and thus the electrical performance of a battery can be improved.

Specifically, since the lithium metal oxide represented by Chemical Formula 1 has a layered structure, contraction and expansion according to charging and discharging of a secondary battery greatly occur. Therefore, in the case of a conventional positive electrode active material in which the lithium metal oxide is contained in a core, the contraction and expansion of the core are repeatedly induced according to charging and discharging of a battery, and thus a shell is detached from the surface of the core to increase electrode resistance, and a contact surface cracking phenomenon is induced at the interface between the active material and an electrolyte, which degrades the lifetime of the battery. However, since the shell according to the present disclosure contains niobium (Nb) and tungsten (W), when the shell is adsorbed onto the core containing the lithium metal oxide represented by Chemical Formula 1, the detachment of the shell, which is caused by contraction and expansion of the core according to charging and discharging of a battery, cannot occur, and a contact surface cracking phenomenon at the interface between an active material and an electrolyte can be substantially improved.

In this case, the shell may contain niobium (Nb) and tungsten (W) in the form of a mixture of niobium oxide particles and tungsten oxide particles or in the form of niobium tungsten oxide particles. Also, the niobium oxide particles may include NbO, NbO₂, Nb₂O₅, Nb₂O₆, and the like, and the tungsten oxide particles may include WO₂, WO₃, W₂O₃, W₂₀O₅₈, W₂₄O₇₀, W₁₈O₄₉, and the like. Also, the niobium tungsten oxide particles may include NbWO₆, Nb₂O₅/WO₃, Nb₈W₉O₄₇, Nb₄W₁₃O₄₇, Nb₇W₁₀O₄₇, Nb₁₄W₃O₄₄, Nb₁₆W₅O₅₅, Nb₁₈ W 16O₉₃, and the like.

As an example, the shell may have a composition in which Nb₂O₆ particles and WO₃ particles are uniformly mixed. In this case, the niobium oxide and the tungsten oxide have advantages of excellent electrical characteristics and high thermodynamic stability.

As another example, the shell may include NbWO₆ particles. In this case, the positive electrode active material exhibits excellent electrical characteristics and high thermodynamic stability, and thus a side reaction between the positive electrode active material and a sulfide-based solid electrolyte during charging and discharging of a battery can be effectively suppressed, and workability can be good.

In addition, the niobium (Nb) and tungsten (W) contained in the shell may be included in an amount of 0.01 to 5 wt %, specifically 0.01 to 3 wt %, 0.01 to 2 wt %, 1 to 2.5 wt %, 1.5 to 2.3 wt %, 1.8 to 2.4 wt %, 0.05 to 1.9 wt %, 0.1 to 1.5 wt %, 0.1 to 0.9 wt %, or 0.8 to 1.8 wt %, with respect to the total weight of the positive electrode active material.

In the present disclosure, by controlling the amount of niobium (Nb) and tungsten (W) contained in the shell within the above-described range, excellent electrical conductivity can be imparted to the surface of the positive electrode active material during charging and discharging of a battery, and an insulating property can be imparted to a shell when the electrochemical action of a battery is not performed (e.g., when charging and discharging are not performed), thereby preventing the battery from being self-discharged.

In addition, the shell may contain niobium (Nb) and tungsten (W) at specific concentrations and/or a specific content ratio.

As an example, the niobium (Nb) may be contained at 2,500 ppm or more with respect to the total positive electrode active material, and the tungsten (W) may be contained at 6,000 ppm or less with respect to the total positive electrode active material.

Specifically, the niobium (Nb) may be contained at 2,800 ppm or more, 3,000 ppm or more, 3,200 ppm or more, 3,500 ppm or more, 4,000 ppm or more, 2,500 to 6,000 ppm, 2,500 to 3,500 ppm, or 2,500 to 3,200 ppm with respect to the total positive electrode active material, and the tungsten (W) may be contained at 5,500 ppm or less, 5,000 ppm or less, 4,500 ppm or less, 4,000 ppm or less, 2,000 to 6,000 ppm, 2,000 to 5,500 ppm, 2,000 to 5,000 ppm, 2,000 to 4,500 ppm, or 2,000 to 4,000 ppm with respect to the total positive electrode active material.

As another example, a content ratio (Nb/W) of niobium (Nb) to tungsten (W) contained in the shell may be 0.1 to 3.0, specifically, 0.5 to 3.0, 0.5 to 2.5, 0.8 to 1.9, 1.1 to 1.8, 1.5 to 2.5, 1.9 to 2.4, or 1.2 to 2.4.

In the present disclosure, by controlling the concentrations and/or content ratio of niobium (Nb) and tungsten (W) contained in the shell of the positive electrode active material within specific ranges, a reaction between cobalt (Co) contained in the core and sulfur (S) contained in a solid electrolyte can be minimized, and accordingly, the charge/discharge performance, specifically, discharge capacity, of the positive electrode active material can be enhanced.

In addition, the positive electrode active material may have an average particle size of 0.5 μm to 10 μm. In this case, particles constituting the shell (i.e., niobium oxide particles and tungsten oxide particles or niobium tungsten oxide particles) may have an average particle size of 0.1 nm to 40 nm.

More specifically, the positive electrode active material may have an average particle size of 0.5 μm to 8 μm, 0.5 μm to 6 μm, 0.5 μm to 5 μm, 0.5 μm to 4 μm, 5 μm to 9 μm, 1 μm to 4 μm, 2 μm to 4 μm, 4 μm to 7 μm, 0.5 μm to 3 μm, 1 μm to 3 μm, or 3 μm to 8 μm, and particles included in the shell of the positive electrode active material may have an average particle size of 0.1 nm to 30 nm, 0.1 nm to 20 nm, 0.1 nm to 10 nm, 5 nm to 30 nm, 5 nm to 20 nm, 8 nm to 15 nm, or 4 nm to 15 nm.

In the present disclosure, by controlling the average particle size of the positive electrode active material within the above-described range, the electrode activity of a positive electrode can be improved. Also, by controlling the average particle size of particles constituting the shell within the above-described range, degradation of the electrical activity of the lithium metal oxide of the core can be minimized, a side reaction at the interface with a solid electrolyte can be effectively suppressed, and cracking that may occur in the positive electrode active material surface can be prevented.

Furthermore, the shell containing niobium (Nb) and tungsten (W) may surround 60% or more of the total surface of the core containing the lithium metal oxide. In this case, particles constituting the shell may be uniformly adsorbed onto the surface of the core containing the lithium metal oxide by a physical bond, not a chemical bond. Specifically, the adsorption area of the particles constituting the shell on the core, may be 60% or more, more specifically, 70% or more, 80% or more, 90% or more, 95% or more, or 98% or more of the total surface area of the core. In the present disclosure, by controlling the area of the shell adsorbed onto the surface of the core containing the lithium metal oxide within the above-described range, a side reaction between the positive electrode active material and a solid electrolyte can be effectively suppressed without using excessive amounts of niobium (Nb) and tungsten (W).

The positive electrode active material for an all-solid-state battery according to the present disclosure is effective for enhancing lithium ion mobility, reducing a side reaction between the positive electrode active material and a solid electrolyte, and thus enhancing the discharge performance of a battery by having the above-described configuration.

### Method of Preparing Positive Electrode Active Material for All-Solid-State Battery

Another aspect of the present disclosure provides a method of preparing a positive electrode active material for an all-solid-state battery, which includes: preparing a mixture including a lithium metal oxide represented by the following Chemical Formula 1 and a niobium (Nb) and tungsten (W)-containing oxide; and thermally treating the mixture:

Liₓ[Ni_{y}Co_{z}Mn_{w}M¹ᵥ]Oᵤ [Chemical Formula 1]
in Chemical Formula 1,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, y, z, w, v, and u satisfy 1.0≤x≤1.30, 0.7≤y≤0.95, z≤0.07, 0.01<w≤0.3, 0≤v≤0.1, and 1.5≤u≤4.5.

The method of preparing a positive electrode active material for an all-solid-state battery according to the present disclosure relates to a method of preparing the above-described positive electrode active material for an all-solid-state battery according to the present disclosure and may be performed by preparing a mixture including a lithium metal oxide represented by Chemical Formula 1, which constitutes a core, and a niobium (Nb) and tungsten (W)-containing oxide constituting a shell and thermally treating the mixture.

In this case, the preparation of a mixture including a lithium metal oxide and a niobium (Nb) and tungsten (W)-containing oxide may be performed using a dry mixer, a stirrer, a shaker such as an orbital shaker or the like, a mortar mixer, or a milling machine such as a planetary ball mill or the like, which is used to mix powders such as metal compounds and the like in the art, but the present disclosure is not limited thereto.

As an example, the preparation of a mixture may be performed with an energy of 1 to 100 kWh/1 kg at 50 to 500 rpm for 0.1 to 10 hours using a planetary ball mill based on 1 kg of the mixture.

As another example, the preparation of a mixture may be performed by mixing for 1 to 10 hours, specifically, 2 to 8 hours using a shaker.

In addition, in the mixture, the lithium metal oxide represented by Chemical Formula 1 may be an oxide including transition metals in addition to lithium, particularly, an oxide having a high nickel content among the transition metals. As an example, the lithium metal oxide may include one or more selected from the group consisting of LiNi_{0.9}Co_{0.05}Mn_{0.05}O₂, LiNi_{0.8}Co_{0.05}Mn_{0.15}O₂, LiNi_{0.7}Co_{0.05}Mn_{0.25}O₂, LiNi_{0.8}Co_{0.05}Mn_{0.1}Al_{0.05}O₂, LiNi_{0.7}Co_{0.05}Mn_{0.15}Al_{0.1}O₂, LiNi_{0.7}Co_{0.05}Mn_{0.2}Al_{0.05}O₂, and LiNi_{0.8}Co_{0.05}Mn_{0.1}Al_{0.05}O₂.

Additionally, the niobium (Nb) and tungsten (W)-containing oxide may include niobium (Nb) and tungsten (W) in the form of a mixture of niobium oxide particles and tungsten oxide particles or in the form of niobium tungsten oxide particles.

In addition, the niobium oxide particles may include NbO, NbO₂, Nb₂O₅, Nb₂O₆, and the like, and the tungsten oxide particles may include WO₂, WO₃, W₂O₃, W₂₀O₅₈, W₂₄O₇₀, W₁₈O₄₉, and the like. Also, the niobium tungsten oxide particles may include NbWO₆, Nb₂O₅/WO₃, Nb₈W₉O₄₇, Nb₄W₁₃O₄₇, Nb₇W₁₀O₄₇, Nb₁₄W₃O₄₄, Nb₁₆W₅O₅₅, Nb₁₈W₁₆O₉₃, and the like.

As an example, the shell may have a composition in which Nb₂O₆ particles and WO₃ particles are uniformly mixed. In this case, the niobium oxide and the tungsten oxide have advantages of excellent electrical characteristics and high thermodynamic stability.

As another example, the shell may include NbWO₆ particles. In this case, the positive electrode active material exhibits excellent electrical characteristics and high thermodynamic stability, and thus a side reaction between a positive electrode active material and a sulfide-based solid electrolyte during charging and discharging of a battery can be effectively suppressed, and workability can be good.

In addition, the mixture may include the niobium (Nb) and tungsten (W)-containing oxide in an amount of 0.01 to 5 wt %, specifically, 0.01 to 3 wt %, 0.01 to 2 wt %, 1 to 2.5 wt %, 1.5 to 2.3 wt %, 1.8 to 2.4 wt %, 0.05 to 1.9 wt %, 0.1 to 1.5 wt %, 0.1 to 0.9 wt %, or 0.8 to 1.8 wt % with respect to the total weight of the mixture.

Additionally, the niobium (Nb) and tungsten (W)-containing oxide may contain niobium (Nb) and tungsten (W) at specific concentrations and/or a specific content ratio.

As an example, the niobium (Nb) may be contained at 2,500 ppm or more with respect to the total mixture, and the tungsten (W) may be contained at 6,000 ppm or less with respect to the total mixture.

Specifically, the niobium (Nb) may be contained at 2,800 ppm or more, 3,000 ppm or more, 3,200 ppm or more, 3,500 ppm or more, 4,000 ppm or more, 2,500 to 6,000 ppm, 2,500 to 3,500 ppm, or 2,500 to 3,200 ppm with respect to the total mixture, and the tungsten (W) may be contained at 5,500 ppm or less, 5,000 ppm or less, 4,500 ppm or less, 4,000 ppm or less, 2,000 to 6,000 ppm, 2,000 to 5,500 ppm, 2,000 to 5,000 ppm, 2,000 to 4,500 ppm, or 2,000 to 4,000 ppm with respect to the total mixture.

As another example, a content ratio (Nb/W) of niobium (Nb) to tungsten (W) contained in the mixture may be 0.1 to 3.0, specifically, 0.5 to 3.0, 0.5 to 2.5, 0.8 to 1.9, 1.1 to 1.8, 1.5 to 2.5, 1.9 to 2.4, or 1.2 to 2.4.

In the present disclosure, by controlling the content ratio and/or concentrations of niobium (Nb) and tungsten (W) contained in the niobium (Nb) and tungsten (W)-containing oxide mixed with the lithium metal oxide, which is the core, within specific ranges, a reaction between cobalt (Co) contained in the core and sulfur (S) contained in a solid electrolyte can be minimized, and accordingly, the charge/discharge performance, specifically, discharge capacity, of a positive electrode active material can be enhanced.

In addition, the thermal treatment of the mixture including the lithium metal oxide and the niobium (Nb) and tungsten (W)-containing oxide is a step for fixing the niobium (Nb) and tungsten (W)-containing oxide physically adsorbed onto the surface of the lithium metal oxide which is the core.

In this case, a thermal treatment temperature may be 300° C. or more, preferably, 300° C. to 480° C., 350° C. to 500° C., 400° C. to 500° C., or 420° C. to 480° C.

In the present disclosure, by controlling the thermal treatment temperature of the mixture including the lithium metal oxide and the niobium (Nb) and tungsten (W)-containing oxide within the above-described range, the niobium (Nb) and tungsten (W)-containing oxide can be easily fixed onto the surface of the lithium metal oxide, which is the core, without any side reaction.

According to the method of preparing a positive electrode active material for an all-solid-state battery of the present disclosure, a shell in which the niobium (Nb) and tungsten (W)-containing oxide is uniformly applied without being aggregated on the surface of the core containing the lithium metal oxide can be formed, and thus preparation efficiency of a positive electrode active material with a core-shell structure can be excellent.

### All-Solid-State Lithium Secondary Battery

Still another aspect of the present disclosure provides an all-solid-state lithium secondary battery, which includes: a positive electrode including the above-described positive electrode active material according to the present disclosure: a negative electrode; and a sulfide-based solid electrolyte disposed between the positive electrode and the negative electrode.

Since the all-solid-state lithium secondary battery according to the present disclosure includes a positive electrode including the above-described positive electrode active material of the present disclosure, a contact surface cracking (void generation) phenomenon that occurs at the interface between the positive electrode active material and the solid electrolyte is substantially minimized, a side reaction is suppressed, and thus lithium ion mobility of an electrode can be excellent, and particularly, the discharge performance of the battery can be enhanced.

In this case, the positive electrode may have a structure in which a positive electrode mixture layer including the above-described positive electrode active material of the present disclosure is formed on a positive electrode current collector.

The positive electrode current collector is not particularly limited as long as it does not cause a chemical change in the battery and has high conductivity, and for example, stainless steel, aluminum, nickel, titanium, calcined carbon, or aluminum or stainless steel whose surface has been treated with carbon, nickel, titanium, silver, or the like may be used.

In addition, the positive electrode mixture layer may include the positive electrode active material, a conductive material, a binder, and a solid electrolyte, and in some cases, may further include an additive.

In this case, the positive electrode active material may include: a core containing a lithium metal oxide represented by the following Chemical Formula 1; and a shell adsorbed onto the surface of the core and containing niobium (Nb) and tungsten (W).

Liₓ[Ni_{y}Co_{z}Mn_{w}M¹ᵥ]Oᵤ [Chemical Formula 1]
in Chemical Formula 1,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, y, z, w, v, and u satisfy 1.0≤x≤1.30, 0.7≤y≤0.95, z≤0.07, 0.01<w≤0.3, 0≤v≤0.1, and 1.5≤u≤4.5.

The lithium metal oxide is not particularly limited as long as it is represented by Chemical Formula 1, and specifically, one or more selected from the group consisting of LiNi_{0.9}Co_{0.05}Mn_{0.05}O₂, LiNi_{0.8}Co_{0.05}Mn_{0.15}O₂, LiNi_{0.7}Co_{0.05}Mn_{0.25}O₂, LiNi_{0.8}Co_{0.05}Mn_{0.1}Al_{0.05}O₂, LiNi_{0.7}Co_{0.05}Mn_{0.15}Al_{0.1}O₂, LiNi_{0.7}Co_{0.05}Mn_{0.2}Al_{0.05}O₂, and LiNi_{0.8}Co_{0.05}Mn_{0.1}Al_{0.05}O₂ may be contained.

In this case, the shell may contain niobium (Nb) and tungsten (W) in the form of a mixture of niobium oxide particles and tungsten oxide particles or in the form of niobium tungsten oxide particles. Also, the niobium oxide particles may include NbO, NbO₂, Nb₂O₅, Nb₂O₆, and the like, and the tungsten oxide particles may include WO₂, WO₃, W₂O₃, W₂₀O₅₈, W₂₄O₇₀, W₁₈O₄₉, and the like. Also, the niobium tungsten oxide particles may include NbWO₆, Nb₂O₅/WO₃, Nb₈W₉O₄₇, Nb₄W₁₃O₄₇, Nb₇W₁₀O₄₇, Nb₁₄W₃O₄₄, Nb₁₆W₅O₅₅, Nb₁₈W₁₆O₉₃, and the like.

As an example, the shell may have a composition in which Nb₂O₆ particles and WO₃ particles are uniformly mixed. In this case, the niobium oxide and the tungsten oxide have advantages of excellent electrical characteristics and high thermodynamic stability.

As another example, the shell may include NbWO₆ particles. In this case, the positive electrode active material exhibits excellent electrical characteristics and high thermodynamic stability, and thus a side reaction between the positive electrode active material and the sulfide-based solid electrolyte during charging and discharging of the battery can be effectively suppressed, and workability can be good.

In addition, the niobium (Nb) and tungsten (W) contained in the shell may be included in an amount of 0.01 to 5 wt % specifically, 0.01 to 3 wt %, 0.01 to 2 wt %, 1 to 2.5 wt %, 1.5 to 2.3 wt %, 1.8 to 2.4 wt %, 0.05 to 1.9 wt %, 0.1 to 1.5 wt %, 0.1 to 0.9 wt %, or 0.8 to 1.8 wt % with respect to the total weight of the positive electrode active material.

In the present disclosure, by controlling the amount of niobium (Nb) and tungsten (W) contained in the shell within the above-described range, excellent electrical conductivity can be imparted to the positive electrode active material surface during charging and discharging of the battery, and an insulating property can be imparted to a shell when the electrochemical action of the battery is not performed (e.g., when charging and discharging are not performed), thereby preventing the battery from being self-discharged.

In addition, the shell may contain niobium (Nb) and tungsten (W) at specific concentrations and/or a specific content ratio.

As an example, the niobium (Nb) may be contained at 2,500 ppm or more with respect to the total positive electrode active material, and the tungsten (W) may be contained at 6,000 ppm or less with respect to the total positive electrode active material.

Specifically, the niobium (Nb) may be contained at 2,800 ppm or more, 3,000 ppm or more, 3,200 ppm or more, 3,500 ppm or more, 4,000 ppm or more, 2,500 to 6,000 ppm, 2,500 to 3,500 ppm, or 2,500 to 3,200 ppm with respect to the total positive electrode active material, and the tungsten (W) may be contained at 5,500 ppm or less, 5,000 ppm or less, 4,500 ppm or less, 4,000 ppm or less, 2,000 to 6,000 ppm, 2,000 to 5,500 ppm, 2,000 to 5,000 ppm, 2,000 to 4,500 ppm, or 2,000 to 4,000 ppm with respect to the total positive electrode active material.

As another example, a content ratio (Nb/W) of niobium (Nb) to tungsten (W) contained in the shell may be 0.1 to 3.0, specifically, 0.5 to 3.0, 0.5 to 2.5, 0.8 to 1.9, 1.1 to 1.8, 1.5 to 2.5, 1.9 to 2.4, or 1.2 to 2.4.

In the present disclosure, by controlling the content ratio and/or concentrations of niobium (Nb) and tungsten (W) contained in the shell of the positive electrode active material within specific ranges, a reaction between cobalt (Co) contained in the core and sulfur (S) contained in the solid electrolyte can be minimized, and accordingly, the charge/discharge performance, specifically, discharge capacity, of the positive electrode active material can be enhanced.

In addition, the conductive material is not particularly limited as long as it does not cause a chemical change in the battery and has conductivity. Specifically, any one or a mixture of graphite, a carbon-based material, a metal powder or metal fiber, an acicular or branched conductive whisker, a conductive metal oxide, and a conductive polymer, may be used. More specifically, any one or a mixture of graphite such as natural graphite, artificial graphite, or the like: a carbon-based material such as carbon black, acetylene black, Ketjen black, channel black, furnace black, lamp black, thermal black, carbon fiber, or the like: a metal powder or metal fiber containing copper, nickel, aluminum, silver, or the like; an acicular or branched conductive whisker such as a zinc oxide whisker, a calcium carbonate whisker, a titanium dioxide whisker, a silicon oxide whisker, a silicon carbide whisker, an aluminum borate whisker, a magnesium borate whisker, a potassium titanate whisker, a silicon nitride whisker, a silicon carbide whisker, an alumina whisker, or the like; a conductive metal oxide such as titanium oxide or the like; and a conductive polymer such as a polyphenylene derivative or the like may be used.

Additionally, the binder for the positive electrode may be any one or a mixture of two or more selected from the group consisting of N,N-bis[3-(triethoxysilyl)propyl]urea, polyethylene oxide (PEO), poly(vinylidene fluoride) (PVDF), and poly(vinylidene fluoride-co-hexafluoropropylene) (PVDF-co-HFP) or any one or a mixture of two or more selected from the group consisting of N,N-bis[3-(triethoxysilyl)propyl]urea, PEO, PVDF, PVDF-co-HFP, conjugated diene-based rubber latex such as acrylonitrile-based styrene butadiene rubber (SBR), acrylonitrile butadiene rubber (NBR), methyl methacrylate-butadiene rubber (MBR), butadiene rubber (BR), and the like, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), a sulfonated EPDM, styrene-butadiene rubber, fluoro-rubber, and various copolymers thereof.

In addition, the negative electrode may have a structure in which a negative electrode mixture layer including a negative electrode active material is formed on a negative electrode current collector.

The negative electrode current collector is not particularly limited as long as it does not cause a chemical change in the battery and has high conductivity, and for example, stainless steel, copper, nickel, titanium, calcined carbon, or stainless steel whose surface has been treated with carbon, nickel, titanium, silver, or the like may be used.

In addition, the negative electrode mixture layer may include the negative electrode active material, a conductive material, a binder, and a solid electrolyte, and in some cases, may further include an additive.

In this case, the negative electrode active material may be one selected from the group consisting of a lithium metal, a lithium alloy, a lithium metal composite oxide, a lithium-containing titanium composite oxide (LTO), and a combination thereof. Here, the lithium alloy may be an alloy composed of lithium and at least one metal selected from Na, K, Rb, Cs, Fr, Be, Mg, Ca, Sr, Ba, Ra, Al, and Sn. Also, the lithium metal composite oxide may be an oxide composed of lithium and any one metal (Me) selected from the group consisting of Si, Sn, Zn, Mg, Cd, Ce, Ni, and Fe and may be, for example, LiₓFe2O₃ (0<x≤1) or LiₓWO₂ (0<x≤1).

In addition, the negative electrode active material may be a metal composite oxide such as SnxMe₁₋ₓMe′_{y}O_{z} (Me: Mn, Fe, Pb, Ge; Me′: Al, B, P, Si, Group 1, Group 2, and Group 3 elements of the periodic table, halogens: 0<x≤1; 1≤y≤3; 1≤z≤8) or the like; an oxide such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, or the like: or the like, and a carbon-based negative electrode active material such as crystalline carbon, amorphous carbon, or a carbon composite may be used alone or in a combination of two or more.

Additionally, the conductive material may be nickel powder, cobalt oxide, titanium oxide, carbon, or the like. As carbon, any one or more selected from the group consisting of Ketjen black, acetylene black, furnace black, graphite, carbon fiber, and fullerene may be used.

In addition, the binder for the negative electrode may be any one or a mixture of two or more selected from the group consisting of N,N-bis[3-(triethoxysilyl)propyl]urea, polyethylene oxide (PEO), poly(vinylidene fluoride) (PVDF), and poly(vinylidene fluoride-co-hexafluoropropylene) (PVDF-co-HFP) or any one or a mixture of two or more selected from the group consisting of N,N-bis[3-(triethoxysilyl)propyl]urea, PEO, PVDF, PVDF-co-HFP, conjugated diene-based rubber latex such as styrene butadiene rubber (SBR), acrylonitrile butadiene rubber (NBR), methyl methacrylate-butadiene rubber (MBR), butadiene rubber (BR), and the like, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), a sulfonated EPDM, styrene-butadiene rubber, fluoro-rubber, and various copolymers thereof.

Furthermore, the solid electrolyte includes sulfide-based particles, and as the sulfide-based particles, any sulfide-based particles that are typically used as an electrolyte of a sulfide-based all-solid-state battery in the art may be used. Specifically, one or more amorphous solid electrolytes selected from the group consisting of Li₂S—SiS₂, LiI—Li₂S—SiS₂, LiI—Li₂S—P₂S₅, Lil—Li₂S—B₂S₃, Li₃PO₄—Li₂S—Si₂S, Li₃PO₄—Li₂S—SiS₂, LiPO₄—Li₂S—SiS, LiI—Li₂S—P₂O₅, LiI—Li₃PO₄—P₂S₅, and Li₂S—P₂S₅ may be used.

The sulfide-based particles may have an average particle diameter of 0.1 μm to 50 μm, specifically, 0.1 μm to 10 μm. In the present disclosure, by controlling the average particle diameter of sulfide-based particles constituting the solid electrolyte within the above-described range, the porosity of the solid electrolyte is increased, and thus degradation of battery capacity can be improved.

Hereinafter, the present disclosure will be described in further detail with reference to examples and experimental examples.

However, it should be understood that the following examples and experimental examples are given for the purpose of illustration only and are not intended to limit the scope of the present disclosure.

### Examples 1 to 3. Preparation of Positive Electrode Active Material for Sulfide-Based All-Solid-State Battery

LiNi_{0.81}Co_{0.05}Mn_{0.12} Al0.02O₂ having an average particle size of 5±0.1 μm and a niobium tungsten oxide (NbWO₆) having an average particle size of 20±5 nm were input into a ball mill jar and subjected to ball milling with an energy of 10 kWh/1 kg at 200±50 rpm for an hour to obtain a mixture in which LiNi_{0.81}Co_{0.05}Mn_{0.12}Al0.02O₂ and the niobium tungsten oxide (NbWO₆) were uniformly mixed. In this case, the total amount and content ratio of niobium (Nb) and tungsten (W) contained in the mixture are shown in Table 1 below.

The mixture was transferred to an oven and then thermally treated at 450±10° C. for 2 hours to obtain a positive electrode active material (average particle size: 5±0.2 μm) in which the niobium tungsten oxide (NbWO₆) was uniformly applied onto the surface of the core LiNi_{0.81}Co_{0.05}Mn_{0.12}Al_{0.02}O₂.

TABLE 1

| | | Content ratio | Proportion of |
|---|---|---|---|
| | Total amount | (Nb/W) of | adsorbed shell area |
| | of Nb and W | Nb and W | relative to core area |
| Example 1 | 0.5 wt % | 2.0~2.3 | about 92% |
| Example 2 | 1.0 wt % | 1.3~1.5 | about 95% |
| Example 3 | 1.5 wt % | 0.4~0.6 | about 99% |

### Comparative Examples 1 to 3. Preparation of Positive Electrode Active Material for Sulfide-Based All-Solid-State Battery

A positive electrode active material (average particle size: 5±0.2 μm) in which a shell was formed on the surface of a core LiNi_{0.81}Co_{0.05}Mn_{0.12}Al_{0.02}O₂ was obtained in the same manner as in Example 1, except that shell components shown in the following Table 2 were used instead of a niobium tungsten oxide (NbWO₆).

TABLE 2

| | | Total amount | |
|---|---|---|---|
| | | of shell | Proportion of |
| | | component | adsorbed shell |
| | Shell | contained in | area relative |
| | component | mixture | to core area |
| Comparative Example 1 | — | — | — |
| Comparative Example 2 | Boron (B) | 1.0 wt % | about 91% |
| Comparative Example 3 | Niobium | 1.0 wt % | about 92% |
| | (Nb) | | |

### Examples 4 to 6 and Comparative Examples 4 to 6. Fabrication of Sulfide-Based All-Solid-State Battery

Each positive electrode active material prepared in Examples 1 to 3 and Comparative Examples 1 to 3 was used to fabricate a sulfide-based all-solid-state battery.

Specifically, each positive electrode active material prepared in Examples 1 to 3 and Comparative Examples 1 to 3, a sulfide-based solid electrolyte (Li₂S—P₂S₅), a conductive material (carbon black), and a binder (PVDF) were mixed in a weight ratio of 80:15:3:2, and the resulting mixture was applied onto an aluminum thin plate (thickness: 40 μm) and roll-pressed at room temperature to manufacture a positive electrode.

Separately, a lithium metal (Li) thin plate (thickness: 40 μm) was prepared as a negative electrode. A solid electrolyte membrane (70 μm, 2.8×10⁻³ S/cm, Li₁₀SnP₂S₁₂) was interposed between the manufactured positive electrode and the prepared negative electrode to fabricate a sulfide-based all-solid-state battery.

TABLE 3

| | Positive electrode active material used |
|---|---|
| Example 4 | Positive electrode active material of Example 1 |
| Example 5 | Positive electrode active material of Example 2 |
| Example 6 | Positive electrode active material of Example 3 |
| Comparative | Positive electrode active material of Comparative |
| Example 4 | Example 1 |
| Comparative | Positive electrode active material of Comparative |
| Example 5 | Example 2 |
| Comparative | Positive electrode active material of Comparative |
| Example 6 | Example 3 |

### Experimental Examples

In order to evaluate the characteristics of the positive electrode active material for the sulfide-based all-solid-state battery according to the present disclosure, experiments were performed as follows.

### A) Analysis of Cross-Sectional Structure of Positive Electrode Mixture Layer

Each sulfide-based all-solid-state battery fabricated in Examples 4 to 6 and Comparative Examples 4 to 6 was prepared in a non-standby state, the lifetime of the battery was advanced under the condition of 3.0 to 4.25 V and 0.1C at room temperature (25±1° C.), each battery was disassembled, and a positive electrode mixture layer was analyzed by scanning electron microscopy (SEM).

As a result, in the case of the batteries of the examples according to the present disclosure, it was confirmed that the shell containing niobium (Nb) and tungsten (W) was uniformly adsorbed onto the surface of the core, lithium metal oxide (LiNi_{0.8}Co_{0.1}Mn_{0.102}).

This means that a contact surface cracking (void generation) phenomenon that occurs at the interface between the lithium metal oxide contained in the core and the sulfide-based solid electrolyte was prevented, and a side reaction and the like were suppressed.

On the other hand, in the case of the batteries of the comparative examples, it was confirmed that cracking occurred between the lithium metal oxide (LiNi_{0.8}CO_{0.1}Mn_{0.1}O₂) which was the core and the sulfide-based solid electrolyte.

From these results, it can be seen that, since the positive electrode active material for the sulfide-based all-solid-state battery according to the present disclosure includes the shell containing niobium and tungsten uniformly adsorbed onto the surface of the core containing the lithium metal oxide, a contact surface cracking (void generation) phenomenon between the lithium metal oxide of the core and the solid electrolyte and side reactions according thereto are prevented from occurring.

### B) Evaluation of Battery Performance

Each sulfide-based all-solid-state battery fabricated in Examples 4 to 6 and Comparative Examples 4 to 6 was fixed to a jig in a 25° C. chamber and subjected to initial charging and discharging under the condition of 0.1 C, then initial charge capacity and initial discharge capacity were measured, and charge/discharge efficiency was calculated therefrom. In this case, the charging was performed by constant current charging (CCC), and c/o was controlled to 0.05 C.

Afterward, the secondary battery was subjected to two cycles of charging and discharging at 25° C., and then discharge capacity was measured. In this case, the charging was performed at a current density of 0.1 C, and the discharging was performed at current densities of 0.1 C and 1 C respectively. From the measurement result, a ratio (1 C/0.1 C) of discharge capacity at 1 C and discharge capacity at 0.1 C was obtained, and results thereof are shown in the following Table 4.

TABLE 4

| | Initial charging and discharging | | | |
|---|---|---|---|---|
| | Charge | Discharge | Charge/discharge | |
| | capacity | capacity | efficiency | 1 C/0.1 C |
| | [mAh/g] | [mAh/g] | [%] | [%] |
| Example 4 | 229 | 192 | 84 | 78 |
| Example 5 | 234 | 196 | 84 | 81 |
| Example 6 | 228 | 170 | 74 | 71 |
| Comparative | 204 | 145 | 71 | 23 |
| Example 4 | | | | |
| Comparative | 218 | 164 | 75 | 65 |
| Example 5 | | | | |
| Comparative | 214 | 165 | 77 | 74 |
| Example 6 | | | | |

As shown in Table 4, it was confirmed that the positive electrode active materials for the sulfide-based all-solid-state batteries of the examples exhibited excellent initial charge/discharge capacity and a high ratio (1 C/0.1 C) of discharge capacity at 1 C and discharge capacity at 0.1 C of 70% or more by having a structure in which a niobium (Nb) and tungsten (W)-containing shell was adsorbed onto the surface of a core containing a lithium metal oxide.

This means that, even when the core of the positive electrode active material of the present disclosure has a high nickel content, there are less cracking at the interface between the positive electrode active material and the solid electrolyte and few side reactions between cobalt contained in the core and the electrolyte, and thus electrode resistance is low.

From these results, in the case of the positive electrode active material for the sulfide-based all-solid-state battery according to the present disclosure, it can be seen that an increase in electrode resistance according to charging and discharging at the interface between the positive electrode active material and the solid electrolyte is prevented, and thus the lifetime of the battery can be enhanced.

While the present disclosure has been described above with reference to the exemplary embodiments, it can be understood by those skilled in the art that various modifications and alterations may be made without departing from the spirit and technical scope of the present disclosure described in the appended claims.

Therefore, the technical scope of the present disclosure should be defined by the appended claims and not limited by the detailed description of the specification.

1. A positive electrode active material for an all-solid-state battery, the positive electrode active material comprising:
a core containing a lithium metal oxide represented by the following Chemical Formula 1; and
a shell adsorbed onto a surface of the core and containing niobium (Nb) and tungsten (W):
Liₓ[Ni_{y}Co_{z}Mn_{w}M¹ᵥ]Oᵤ [Chemical Formula 1]
in Chemical Formula 1,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, y, z, w, v, and u satisfy 1.0≤x≤1.30, 0.7≤y≤0.95, z≤0.07, 0.01<w≤0.3, 0≤v≤0.1, and 1.5≤u≤4.5.

2. The positive electrode active material of claim 1, wherein niobium (Nb) and tungsten (W) are in the form of a mixture of niobium oxide particles and tungsten oxide particles or in the form of niobium tungsten oxide particles.

3. The positive electrode active material of claim 1, wherein the niobium (Nb) and tungsten (W) are contained in an amount of 0.01 to 5 wt % with respect to the total weight of the positive electrode active material.

4. The positive electrode active material of claim 1, wherein the niobium (Nb) is contained at 2,500 ppm or more with respect to the total positive electrode active material, and
the tungsten (W) is contained at 6,000 ppm or less with respect to the total positive electrode active material.

5. The positive electrode active material of claim 1, wherein a content ratio (Nb/W) of the niobium (Nb) to the tungsten (W) is 0.1 to 3.0.

6. The positive electrode active material of claim 1, wherein the positive electrode active material has an average particle size of 0.5 μm to 10 μm.

7. The positive electrode active material of claim 1, wherein the shell is adsorbed onto 60% or more of the total surface area of the core.

8. A method of preparing a positive electrode active material for an all-solid-state battery, the method comprising:
preparing a mixture including a lithium metal oxide represented by the following Chemical Formula 1 and a niobium (Nb) and tungsten (W)-containing oxide; and
thermally treating the mixture,
Liₓ[Ni_{y}Co_{z}Mn_{w}M¹ᵥ]Oᵤ [Chemical Formula 1]
in Chemical Formula 1,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, y, z, w, v, and u satisfy 1.0≤x≤1.30, 0.7≤y≤0.95, z≤0.07, 0.01<w≤0.3, 0≤v≤0.1, and 1.5≤u≤4.5.

9. The method of claim 8, wherein the niobium (Nb) and tungsten (W)-containing oxide is included in an amount of 0.1 to 10 wt % with respect to the total weight of the mixture.

10. The method of claim 8, wherein the thermally treating is performed at 300° C. to 500° C.

11. An all-solid-state lithium secondary battery comprising:
a positive electrode including the positive electrode active material according to claim 1;
a negative electrode; and
a sulfide-based solid electrolyte disposed between the positive electrode and the negative electrode.

12. The all-solid-state lithium secondary battery of claim 11, wherein the sulfide-based solid electrolyte includes one or more selected from the group consisting of Li₂S—SiS₂, LiI—Li₂S—SiS₂, LiI—Li₂S—P₂S₅, LiI—Li₂S—B₂S₃, Li₃PO₄—Li₂S—Si₂S, Li₃PO₄—Li₂S—SiS₂, LiPO₄—Li₂S—SiS, LiI—Li₂S—P₂O₅, and Li₂S—P₂S₅.
